(19) United States
(12) Patent Application Publication
(10) Pub. No.: US 2013/0042531 A1
(43) Pub. Date: Feb. 21, 2013

(54) GATE OPERATOR, METHOD FOR MANUFACTURING SAME AND FOLDED GATE ASSEMBLY UTILIZING SAME

(71) Applicants: Arthur Douglas Hird, JR., San Carlos, CA (US); John Martin, Discovery Bay, CA (US)

(72) Inventors: Arthur Douglas Hird, JR., San Carlos, CA (US); John Martin, Discovery Bay, CA (US)

(73) Assignee: ADVANTAGE GATE PRODUCTS INC., Redwood City, CA (US)

(21) Appl. No.: 13/371,376

(22) Filed: Feb. 10, 2012

Related U.S. Application Data
(60) Provisional application No. 61/463,047, filed on Feb. 10, 2011.

(51) Int. Cl. E05F 15/00; E05F 15/20; B23P 11/00; E05D 15/28; B23K 26/38; B21D 31/00

(52) U.S. Cl. 49/246; 219/121.72; 72/369; 72/379.2; 29/428; 49/349

(57) ABSTRACT

A gate operator for opening and closing an exterior gate includes an elongate hollow housing for rigid vertical mounting relative to the ground. First and second spaced-apart hinge assemblies for securing to the gate are mounted within the housing for pivoting relative to the housing. A motor is mounted within the housing and is coupled to at least one of the first and second hinge assemblies for causing the at least one of the first and second hinge assemblies to pivot between first and second positions and thus cause the gate to pivot between opened and closed positions. A method for manufacturing the gate operator and a folded gate assembly utilizing the gate operator are provided.

### CROSS REFERENCE TO RELATED APPLICATIONS

This application claims priority to U.S. provisional patent application Ser. No. 61/463,047 filed Feb. 10, 2011, the entire content of which is incorporated herein by this reference.

### TECHNICAL FIELD

This application relates to gate operators and, more particularly to gate operators for use with exterior gates.

### BACKGROUND ART

Residential and commercial gate operators have been provided, particularly for exterior gates for use on driveways and other areas accessible by automobiles and trucks. It has been found, however, that there is a need for a gate operator that incorporates most if not all of the components of the gate operator into a single housing.

### BRIEF DESCRIPTION OF THE DRAWING

FIG. 1 is a front elevational view of an embodiment of a gate operator of the present invention mounted on the ground and having a gate mounted thereto in a closed position.

FIG. 2 is a side elevational view of the gate operator of FIG. 1 taken along the line 2-2 of FIG. 1.

FIG. 3 is a rear elevational view of the gate operator of FIG. 1 taken along the line 3-3 of FIG. 2.

FIG. 4 is a top plan view of the gate operator of FIG. 1 taken along the line 4-4 of FIG. 3.

FIG. 5 is a bottom plan view of the gate operator of FIG. 1 taken along the line 5-5 of FIG. 3.

FIG. 6 is a cross-sectional view of the gate operator of FIG. 1 taken along the line 6-6 of FIG. 2.

FIG. 7 is a cross-sectional view of the gate operator of FIG. 1 taken along the line 7-7 of FIG. 6.

FIG. 8 is a cross-sectional view of the gate operator of FIG. 1 taken along the line 8-8 of FIG. 6.

FIG. 9 is an exploded view of the gate operator of FIG. 1.

FIG. 10 is a cross-sectional view, similar to FIG. 6, of a portion of another embodiment of the gate operator of the present invention.

FIG. 11 is a perspective view of a plurality of metal sheets, after being bent from their planar stock configuration, used to form the housing of the gate operator of FIGS. 1 and 10.

FIG. 12 is a front elevational view of an embodiment of a folded gate assembly, in a closed position, utilizing the gate operator of FIG. 1.

FIG. 13 is an enlarged view of the top portion of the folded gate assembly of FIG. 12.

FIG. 14 is a top plan view of the folded gate assembly of FIG. 12 taken along the line 14-14 of FIG. 13.

FIG. 15 is a top plan view, similar to FIG. 14 but schematic at parts, of the folded gate assembly of FIG. 12 in a partially opened position.

FIG. 16 is a top plan view, similar to FIG. 14 but schematic at parts, of the folded gate assembly of FIG. 12 in a fully opened position.

FIG. 17 is a perspective view, schematic at parts, of a top portion of another embodiment of the folded gate assembly of the present invention.

### DESCRIPTION OF THE INVENTION

Reference is now made in detail to certain embodiments of the present invention, examples of which are illustrated in the accompanying drawings. While the invention will be described in conjunction with such embodiments, it is understood that such description is not intended to limit the invention to such embodiments. On the contrary, the invention is intended to cover alternatives, modifications and equivalents which may be included within the spirit and scope of the invention, including as defined by the appended claims.

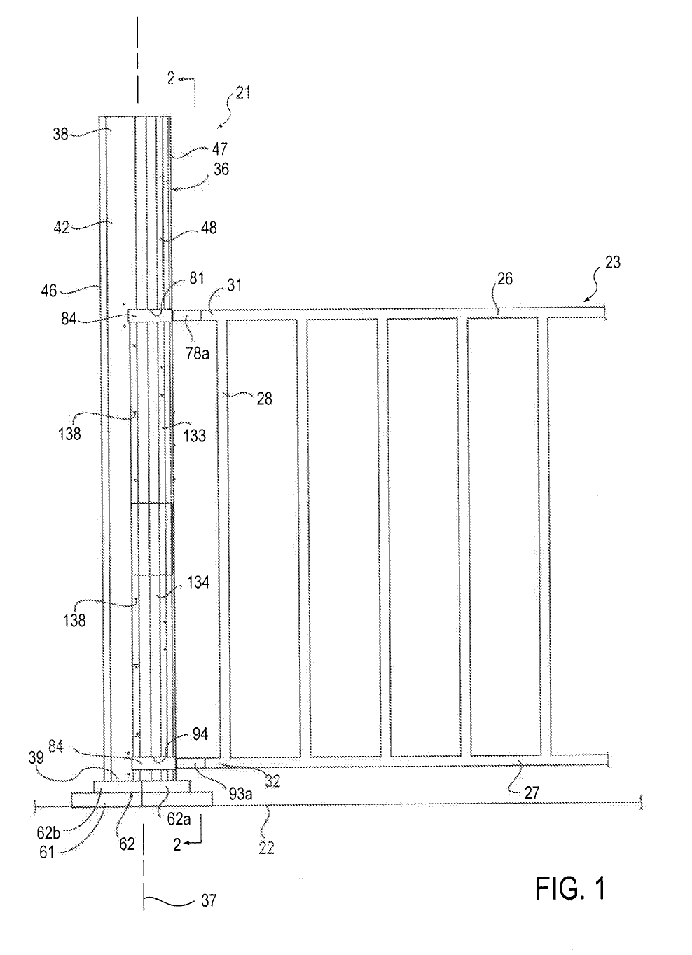

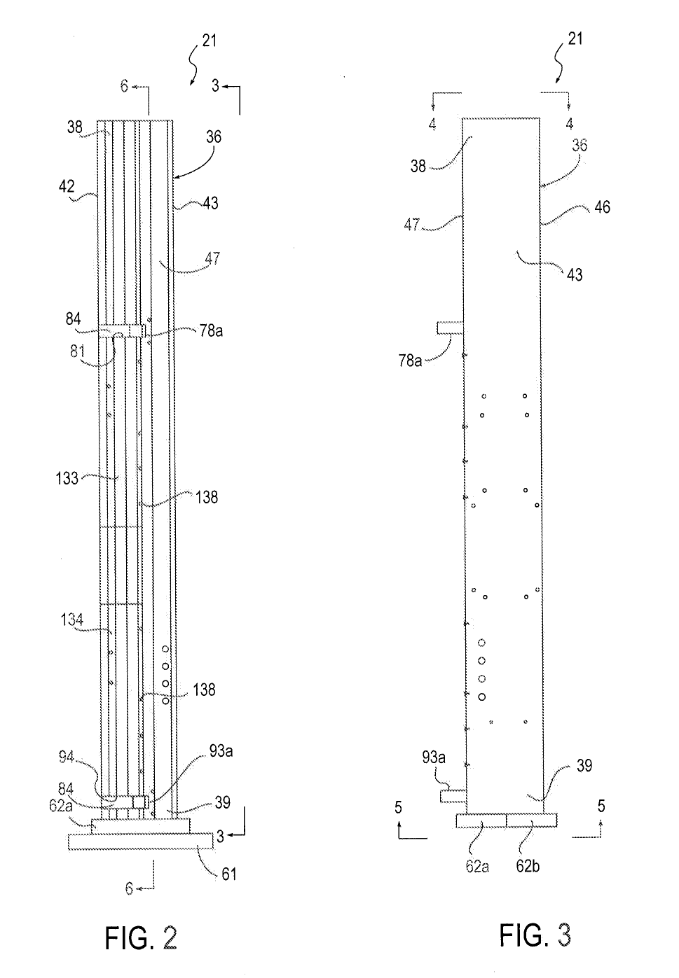

Gate operator 21 of the present inventor is for use on a support surface to open and close a gate (see FIG. 1). In one embodiment, the gate operator 21 is for use on ground 22 to open and close an exterior gate 23 that can be a single fold or multiple fold gate. The exterior gate 23 has a top portion 26 and a bottom portion 27 and a first side portion 28 having upper and lower attachment members or arms 31 and 32. The exterior gate can be made from any suitable material such as wood or metal and in one embodiment is made of stainless steel.

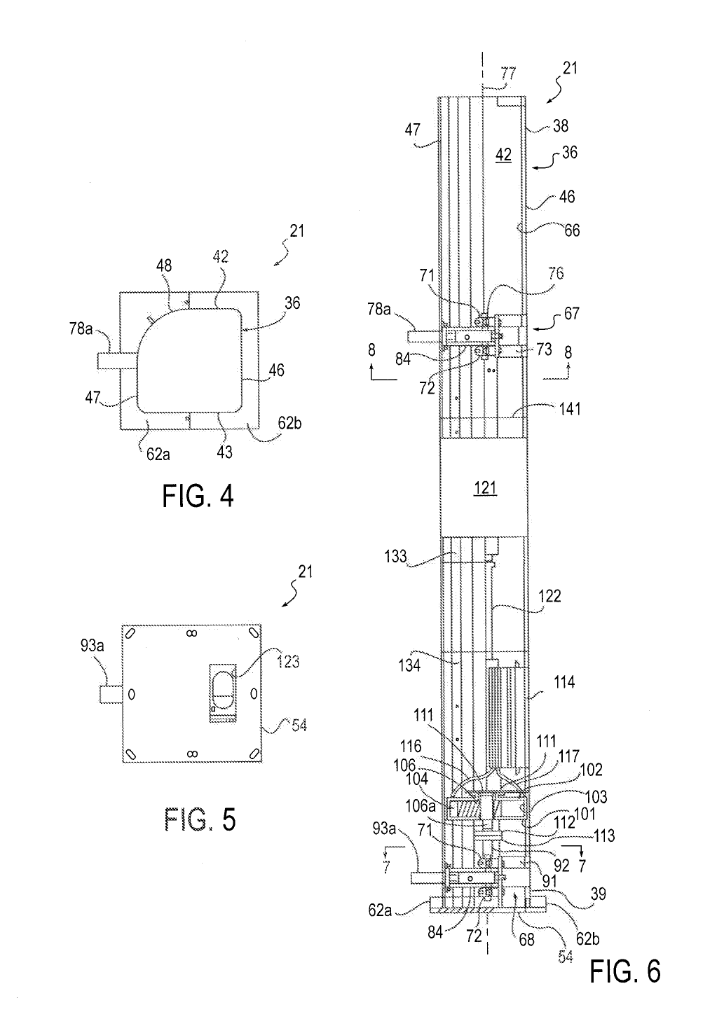

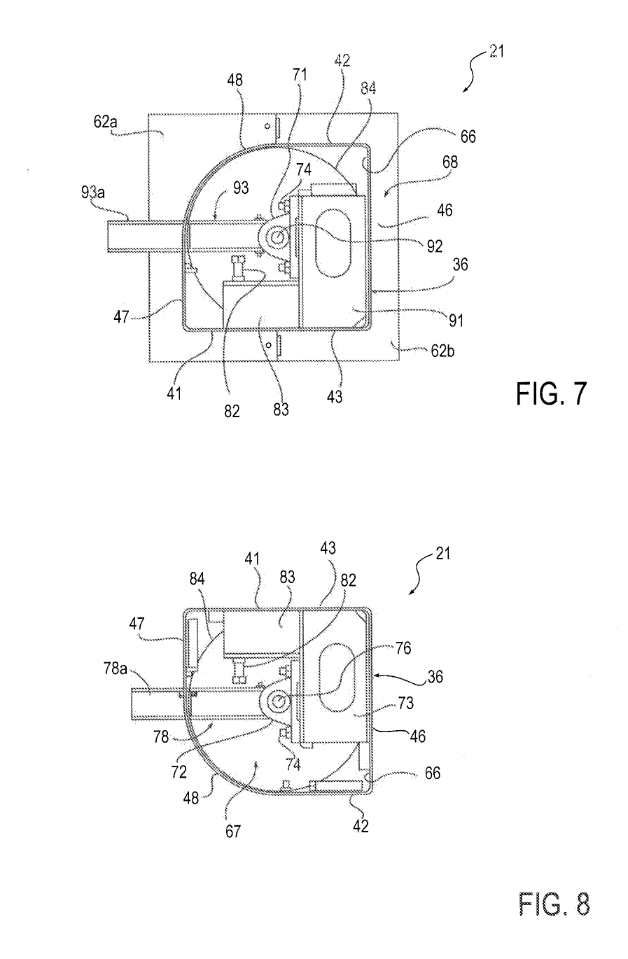

Gate operator 21 is formed from an elongate hollow housing 36 adapted for rigid vertical mounting to the ground 22. The elongate housing 36 extends along an axis, such as a vertical axis 37, and has a top end 38 and a bottom end 39. The housing can be cylindrical in conformation and, in this regard, provided with a horizontal cross section perpendicular to vertical axis 37 that is relatively constant along the vertical axis of the housing 36 (see FIGS. 4, 7 and 8). In one embodiment, the housing 36 is formed from a peripheral or circumferential wall 41 (see FIGS. 7-9). As illustrated in FIGS. 4, 7 and 8, the elongate housing 36 can have a front wall portion 42 and a rear wall portion 43, which are each substantially planar and extend substantially parallel to each other, and a first side wall portion 46 and a second side wall portion 47 extending perpendicular to front and rear wall portions 42 and 43. More specifically, first side wall portion 46 extends between front and rear wall portions 42 and 43 and second side wall portions 47 extends forwardly from rear wall portion 43. Circumferential wall 41 has an arcuate wall portion 48 extending between front wall portion 42 and second side wall portion 47. Elongate housing 36 has top and bottom planar end surfaces 51 and 52, which each extend perpendicular to vertical axis 37. A top plate 53 can be welded or otherwise secured to top end 51 and has a shape corresponding to the cross-sectional shape of housing 36 so as to be flush with the top end 38 of the housing 36 (see FIG. 4). A base or foot plate 54 is welded or otherwise secured to bottom end surface 52 and in one embodiment is rectangular in shape and dimensioned so as to have a larger cross-sectional shape than the cross-sectional shape of the housing 36 so that the periphery of the foot plate 54 extends beyond the circumferential wall 41 of the housing 36.

Each of the circumferential wall 41, top plate 53 and foot plate 54 can be made from any suitable material and be of any suitable thickness. In one embodiment, circumferential wall 41 is formed from a sheet of a suitable metal such as steel having a thickness of approximately 0.2 inch, top plate 53 is formed from a sheet of a suitable metal such as stainless steel having a thickness of approximately 0.1 inch and foot plate 54 is formed from a sheet of a suitable material such as steel having a thickness of approximately 0.5 inch. The gate operator 21 can be of any suitable size and in one embodiment has a height from top plate 53 to foot plate 54 of approximately 10 feet. In such one embodiment, as illustrated for example in FIGS. 4, 7 and 8, each of rear wall portion 43 and first side wall portion 46 have a width of approximately 12.4 inches and each of front wall portion 42 and second side wall portion 47 have a width of approximately 5.2 inches. Arcuate wall portion 48 can be of any suitable size and shape and in one embodiment approximates an arc of a circle extending through an angle of approximately 90 degrees and having a radius of approximately 6.2 inches.

Foot plate 54 permits elongate housing 36 to be mounted to the ground 22. In one embodiment, a footing 61 made from any suitable materials such as concrete is provided in ground 62. The periphery of foot plate 54 can be provided with a plurality of holes 62 extending therethrough for permitting a respective plurality of bolts (not shown) to secure the foot plate 54 to the footing 61. A cover 62, made for any suitable material such as metal and in one embodiment made from stainless steel, can he provided to overlie foot plate 54. The cover 62 can be formed in two half portions 62a and 62b, which can be joined together around bottom 69 of the elongate housing 36 and secured together by any suitable means such as a plurality of bolts or other fasteners (not shown). The cover 62 has a central opening 63 which is sized and shaped to snugly engage the periphery of the circumferential wall 41 of the elongate housing 36.

Circumferential wall 41, top plate 53 and foot plate 54 of the elongate hollow housing 36 form an internal cavity 66 for receiving the components of the gate operator 21 and in one embodiment for receiving all of the components of the gate operator 21 (see FIGS. 6-8). In this regard, a first or upper hinge assembly 67 and a second or lower hinge assembly 68 are provided within internal cavity 66 and mounted within the elongate housing 36 in vertically spaced-apart positions. Upper hinge assembly 67 is mounted in top portion of the housing 36 inside or below top end surface 51 and lower hinge assembly 68 is mounted in the bottom portion of the housing 36 above bottom end surface 52. The upper hinge assembly 67 includes a first or upper bearing assembly 71 and a second or lower bearing assembly 72 mounted in vertically spaced-apart positions within housing 36 by means of a mount 73 secured to the inside of circumferential wall 41 by any suitable means such as welding. Each of the bearing assembles 71 and 72 can be of any suitable type and in one embodiment are each a pillow block bearing secured to the mount 73 by any suitable means such as one or more bolts or other fasteners 74. In one embodiment, each of the bearing assemblies 71 and 72 is a flange bearing. A cylindrical hinge shaft 76, made from any suitable metal or other material, extends between upper and lower bearings 71 and 72 and pivots about a vertical hinge axis 77 extending parallel to vertical axis 37 of elongate housing 36. The diameter of hinge shaft 76 can be of any suitable size, and in one embodiment is approximately one inch. A hinge arm 78 made for any suitable material such as metal is secured to the hinge shaft 76 between upper and lower bearings 71 and 72 and extends perpendicular to vertical hinge axis 77.

A horizontally-extending slot 81 is provided in circumferential wall 41 of the elongate housing 36 and can extend approximately along the entire arc of arcuate portion 48 adjacent upper hinge assembly 67. The upper hinge arm 78 has an end portion 78a that extends through the upper slot 81 and pivots with upper hinge shaft 76 relative to the elongate housing 36 about the vertical hinge axis 77. The upper slot 81 has a height at least slightly larger than the height of hinge end portion 78a. The upper hinge arm 78 pivots about vertical hinge axis 77 between a first position, illustrated in FIG. 8 and in which hinge end portion 78a is at one end of upper slot 81, and a second position in which the hinge end portion 78a can be at the other end of the upper slot 81. In one embodiment, the upper hinge arm 78 travels through an angle of approximately 90 degrees between its first and second positions. A positive stop 82 can be provided within housing 36 for limiting the travel of upper hinge arm 78 at its first end position. In one embodiment, the upper positive stop 82 is secured to a metal mount 83 secured to the inside of rear wall portion 43 by any suitable means such as welding. A second positive stop (not shown) can be provided for limiting the movement of hinge end portion 78a at its second end position and can be of a similar construction as positive stop 82 and be secured to circumferential wall 41 by a mount similar to mount 83.

A flexible ring or band 84 made for any suitable material such as metal, for example stainless steel, can be provided for covering upper slot 81 when upper hinge end portion 78a is in its first or second end positions or any position therebetween. In one embodiment, band 84 extends around circumferential wall 41 in the vicinity of upper bearing assembly 71 and has a width at least equal to the height of upper slot 81. The band 84 can have opposite end portions 84a which join together around upper hinge arm 78 at slot 81 and are secured together by any suitable means such as one or more fasteners (not shown).

Lower hinge assembly 68 can be of any suitable type and in one embodiment is substantially similar in construction to the upper hinge assembly 67. In this regard, the lower hinge assembly 68 can include an upper bearing 71 and a lower bearing 72 secured by fasteners 74 in vertically spaced-apart positions to a mount 93. Each of the bearings 71 and 72 can be of any suitable type, such as discussed above with respect to upper hinge assembly 67. The mount 93 can be substantially similar to mount 73 and be secured to the inside of first side wall portion 46 in internal wall cavity 66 by any suitable means such as welding. A lower hinge shaft 92, that can be substantially similar to upper hinge shaft 76, is included in lower hinge assembly 68 and is rotatably coupled to the bearings 71 and 72 of the assembly 68 concentric with vertical hinge axis 77. The lower hinge shaft 92 can be of any suitable size, including the size discussed above for upper hinge shaft 76. In one embodiment, the size of lower hinge shaft 92 is approximately 1.5 inch, but tapers to approximately one inch at lower bearing assembly 72 so as to seat upon the race of the lower bearing assembly 72. It is appreciated that such a tapered shaft 92 can be provided with other dimensions. In this manner, the increased vertical loads, for example from gate 23, can be supported by the lower hinge assembly 68. A lower hinge arm 93 having an end portion 93a, and substantially similar to upper hinge arm 78, is included in lower hinge assembly 68 and secured to lower hinge shaft 92 between bearings 71 and 72 in substantially the same manner that the upper hinge arm 78 is secured to the upper hinge shaft 76.

A lower slot 94, substantially similar to upper slot 81, is provided in arcuate portion 48 of the circumferential wall 41 in the vicinity of lower hinge assembly 68. The hinge end portion 93a extends through slot 94 and pivots between a first position, illustrated in FIG. 7, in which the lower hinge arm 93 can be at one end of slot 94 and a second position (not shown) in which the lower hinge arm is in another position in slot 94. In one embodiment, the lower hinge arm 93 moves from its first position through an angle of approximately 90 degrees to its second position at the other end of slot 94. A positive stop 82 joined to rear wall portion 43 by means of a mount 83 is provided for limiting the travel of the lower hinge arm 93 in its first end position (see FIG. 7). An optional second positive stop (not shown), substantially similar to positive stop 82, can be provided for limiting the travel of the lower hinge arm 93 in its second end position. An additional band 84 is provided and, similar to the band 84 of upper hinge assembly 67, extends around internal cavity 66 and has end portions 84a secured around the hinge end portion 93a for covering lower slot 94 when the lower hinge arm 93 is in any position within the lower slot 94. Lower hinge arm 93 pivots about vertical hinge axis 77 relative to the elongate housing 36 between first and second positions.

In one embodiment, the center of lower hinge arm 93 is approximately 6.3 inches above the bottom of foot plate 54 and the center of upper hinge arm 78 is approximately 80 inches above such center of the lower hinge arm 93.

A motor 101 is included within gate operator 21 and is coupled to at least one of upper hinge assembly 67 and lower hinge assembly 68 for causing the hinge arm of such hinge assembly to pivot between first and second positions relative to the elongate housing 36. Motor 101 is mounted in internal cavity 66 between top end surface 51 arid lower end surface 52 of the elongate housing 36. In one embodiment, motor 101 is mounted between upper hinge assembly 67 and lower hinge assembly 68. Motor 101 can be mounted within elongate housing 36 and coupled to the lower hinge assembly for driving lower hinge shaft 62 of the assembly 68. Motor 101 can be of any suitable type and in one embodiment is a suitable hydraulic motor such as a rack and pinion motor made by FAAC of Bolognia, Italy and having its US headquarters in Cheyenne, Wyo. Such rotary actuator or motor 101 includes a housing 102 having an internal elongate chamber 103. Rack and pinion gearbox or housing 102 includes a rack 104 having linear gear or teeth thereon that is slidably mounted within chamber 103 and an externally-geared circular pinion or pivotable member 106 that engages the teeth of rack 104 and rotates about a motor axis. The pivotable member 106 has an end portion 106a protruding from housing 102. Motor 101 is mounted within gate operator 21 in any suitable manner and one embodiment is bolted to a bracket 111 welded or otherwise suitable joined to the inside of circumferential wall 41.

The motor 101 is positioned within elongate housing 36 so that the cylindrical or pivotable member 106, and the motor axis about which the member 106 pivots, is concentric with vertical hinge axis 77. The exposed end portion 106a of the pivotable member 106 is connected to lower hinge shaft 92 of the lower hinge assembly 68 by any suitable manner. In one embodiment the end portion 106a of the pivotable member 106 is provided with a flange 112 and the upper end of lower hinge shaft 92 is provided with a complimentary flange 113 which is rigidly secured to flange 112 by any suitable means such as a plurality of bolts or other fasteners (not shown).

A suitable hydraulic pump 114 is provided in gate operator 21 for providing hydraulic fluid flow to motor 101. In one embodiment, pump 114 is a model 750 hydraulic pump of FAAC of Bolognia, Italy and is mounted to the inside of circumferential wall 41 above motor 101 by any suitable means such as a plurality of fasteners (not shown). A first tube 116 extends from pump 114 to one end of motor housing 102 and a second tube 117 extends from hydraulic pump 114 to the other end of motor housing 102, illustrated in FIG. 6, for selectively driving rack 104 linearly in opposite first and second directions within chamber 103 of the housing 102. The linear movement of motor rack 104 pivots pivotable member 106 and lower hinge shaft 92 secured to the pivotable member 106, and thus pivots lower hinge arm 93 joined to the pivotable member 106, about vertical hinge axis 77 relative to the elongate housing 36.

A suitable controller 121 is provided within gate operator 21 for controlling the operation of motor 101 and thus lower hinge arm 93. In one embodiment, controller 121 is an electronic controller, for example Model 455D control panel FAAC of Bolognia, Italy, and is mounted to the inside of circumferential wall 41 within cavity of 66 of the elongate housing 36 by any suitable means such as a metal bracket welded or otherwise secured to the wall 41 and suitable fasteners for securing the controller 121 to the bracket. The controller 121 is electrically coupled by any suitable means, such as a conduit 122 for carrying electrical wires, to hydraulic pump 114 and can be powered by any suitable means such as a battery or current provided by a power cable. Foot plate 54 is provided with an opening 123, illustrated in FIG. 5, for permitting power, control signals or any other suitable wiring or cabling to the inside of elongate housing 36 and thus gate operator 21.

It is appreciated that other types of motors can be provided for driving one or both of hinge assemblies 67 and 68. In one embodiment, an electric motor (not shown) is substituted for motor 101 and hydraulic pump 114 and is mounted within elongate housing 36 at a suitable location by any suitable means for driving one or both of the hinge assemblies 67 and 68. For example, such electric motor can be secured to circumferential wall 41 above lower hinge assembly 68, by means of bracket 111 or otherwise, for rotatably driving lower hinge shaft 92 of the lower hinge assembly 68. It is appreciated that both an electric motor and hydraulic motor, together or separately, can be included in gate operator 21.

Gate operator 21 can be provided with one or more openings in elongate housing 36 for permitting access to the internal components of the gate operator 21. In one embodiment, the elongate housing 36 is provided with a first or upper opening 131 and a second or lower opening 132 provided in circumferential wall 41. In the illustrated embodiment, each of the openings 131 and 132 is provided in arcuate portion 48, with the upper opening 131 adjoining the bottom of upper slot 81 and the lower opening 132 adjoining the top of lower slot of 94. A first or upper door 133 and a second or lower door 134 can be provided for covering the respective openings 131 and 132 and thus contributing to the aesthetic appearance of the gate operator 21. In one embodiment, each of the doors 133 and 134 is formed from metal and more specifically can be formed from the same metal as that forming circumferential wall 41. Each of the doors 133 and 134 can be removably secured to elongate housing 36 in any suitable manner. In one embodiment, a recessed lip or bracket 136 is provided along each side of each of the upper opening 131 and each side of the lower opening 132 for permitting attachment of the respective door to the opening. In one embodiment, each lip 136 is formed from a strip attached to the inside of the circumferential wall 41 alongside the opening. An optional stop 137 formed from a strip of any suitable material such as rubber or plastic can be secured to each lip 136 for facilitating a tight seal between the respective door and the circumferential wall 41 of the housing 36 at the opening. The upper door 133 and lower door 134 can each have an arcuate cross section approximating the cross section of arcuate portion 48, and can each be provided with a plurality of openings 138 along each side thereof for permitting the door to be secured to the circumferential wall 41 at the respective opening by any suitable means such as a plurality of fasteners extending through the holes 138 and lips 136, for example the first and second lips adjoining each opening.

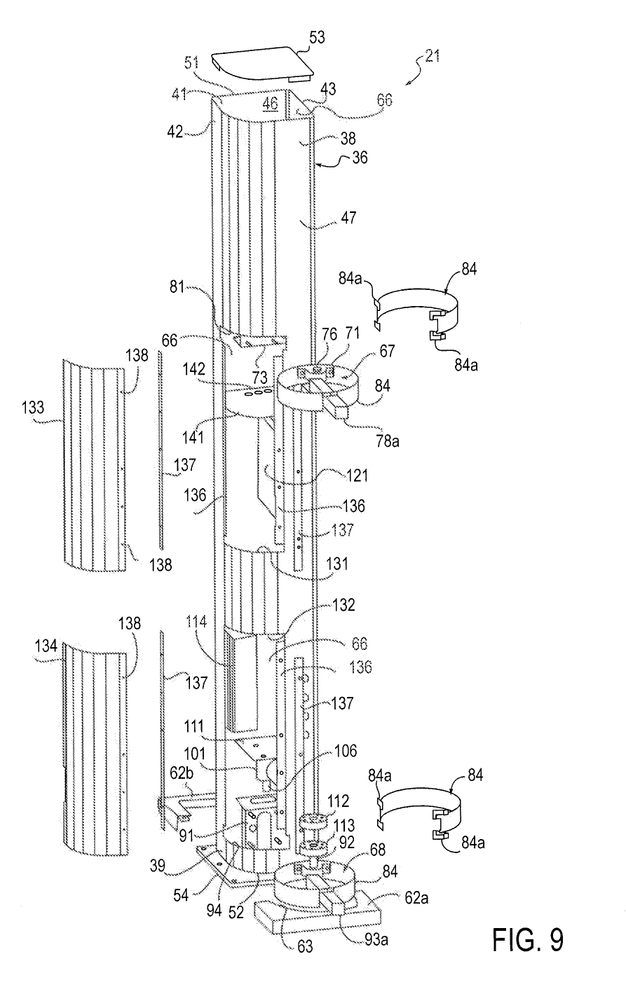

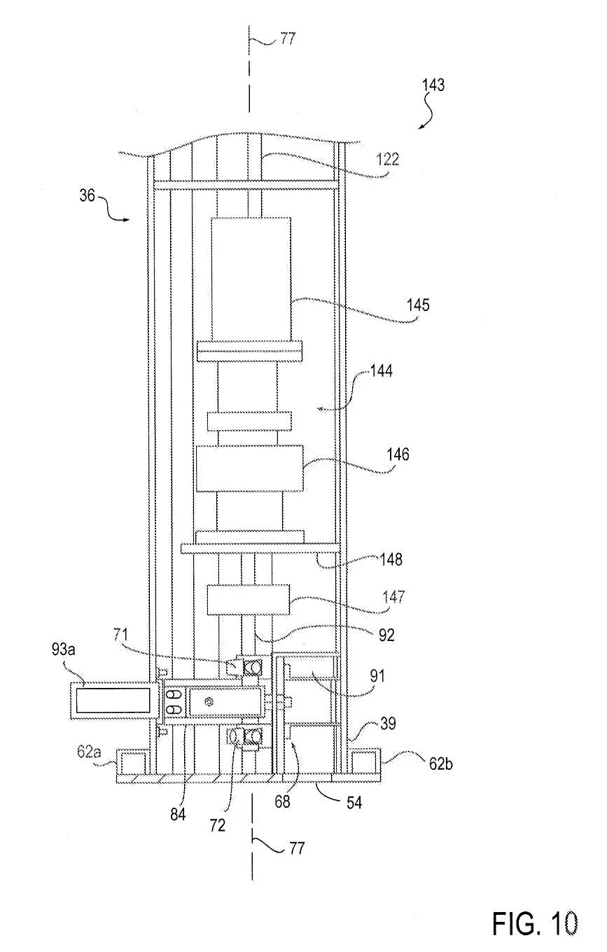

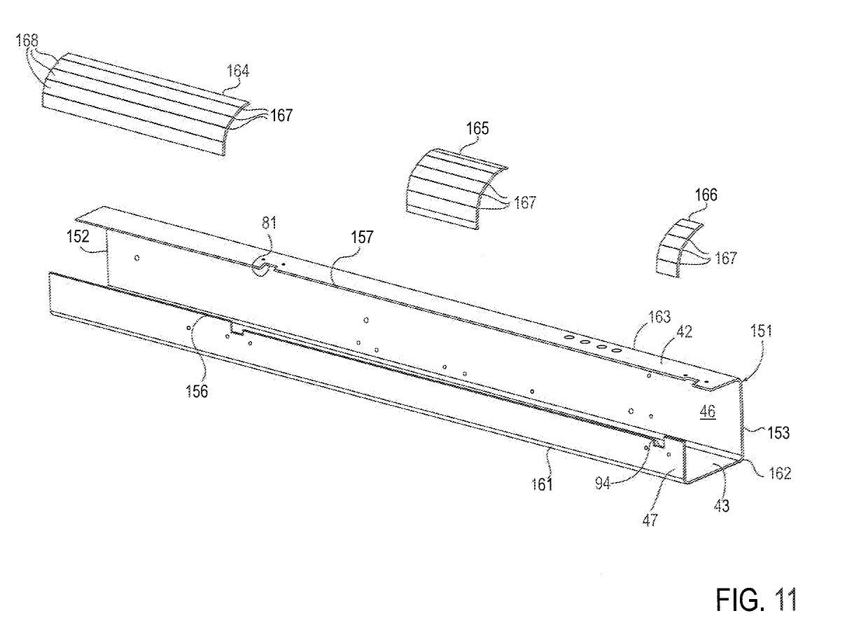

One or more structural supports can be provided in internal cavity 66 of elongate housing 36 for further enhancing the structural rigidity of the housing 36. In one embodiment, each of the structural supports can be in the form of a plate 141 made of any suitable material such as metal. The one or more structural plates 141 can each have a shape approximating the cross-sectional shape of internal cavity 66 as to flushly engage each of the wall portions 42, 43, 46, 47 and 48 of the circumferential wall 41 when disposed perpendicular to vertical axis 37 of the housing 36. The structural plates 141 can each be secured to the inside of circumferential wall 41 by any suitable manner such as welding, and the vertical spacing of the one or more structural plates 141 in cavity 66 can be chosen so as to best enhance the structural rigidity of the elongate housing 36. One such structural plate 141 is shown in FIG. 9, and is located between mount 73 of upper hinge assembly 67 and controller 121. As illustrated therein, the structural plate 141 can optionally include a plurality of apertures 142 extending therethrough for permitting cables, conduits, wires and similar components of gate operator 21 to vertically pass through the structural plate 141.

One embodiment of a portion of a gate operator with an electric motor is illustrated in FIG. 10. Gate operator 143 illustrated in FIG. 10 is substantially similar to gate operator 23 and like reference numerals have been used to describe like components of gate operators 23 and 143. The gate operator 143 includes an electric or other motor assembly 144 that is located within housing 36 in any suitable location. In one embodiment, the motor assembly 144 is mounted in the housing 36 between the top end 38 and bottom end 39, and in one embodiment between the upper hinge assembly 67 and the lower hinge assembly 68. The motor assembly 144 can be coupled to at least one of the hinge assemblies 67 and 68, and in one embodiment is coupled to the lower hinge assembly 68. In one embodiment the motor assembly 144 is mounted above and coupled to the lower hinge assembly 68. Although any suitable motor assembly can be provided, in one embodiment the assembly 144 includes a suitable electric motor 145, such as a one half horsepower instant reversing motor manufactured by Leeson of Grafton, Wis. A suitable speed reducer, such as speed reducer 146 made by Sumitomo Drive Technologies of Sumitomo Machinery Corporation of America located in Chesapeake, Va., can be included in motor assembly 144, and the motor assembly can include a suitable clutch 147. In one embodiment, the speed reducer is mounted to a bracket 148, for example made from any suitable material such as metal or steel, secured to the inside of housing 36 above the lower hinge assembly 68. The speed reducer 146 is bolted or other fastened to the top of the bracket 148, and the electric motor 145 sits atop and is bolted or otherwise fastened to the top of the speed reducer. Clutch 147 is disposed beneath the bracket and coupled or secured, through the bracket, to the bottom of the speed reducer. The lower hinge shaft 92 extends from the bottom of the clutch 147. The motor assembly 144 can be electrically coupled to controller 121 by any suitable means, such as by conduit 122 that can carry electrical wires to the assembly, and can be powered by any suitable means such as a battery or current provided by a power cable.

In another aspect of the invention, a method is provided for manufacturing gate operator 21 which can serve as a gate post for the gate 23 attached thereto. Such method includes providing at least one sheet of metal 151 made from any suitable material such as steel having a thickness of approximately 0.2 inch. The metal sheet 151 is cut or preformed to have a length between its first or top end 152 and its second or bottom end 153 that approximates the height of circumferential wall 41 and thus elongate housing 36. The sheet 151 is further provided with first and second opposite sides 156 and 157. In one step of the method, sides 156 and 157 can be cut, for example by any suitable means such as conventional laser cutting, to conform to the sides of upper and lower slots 81 and 94 and upper and lower openings 131 and 132 and the opposite sides of arcuate portion 48 (see FIG. 10). In another step of the method, a plurality of apertures can be formed in the sheet 151 by any suitable means such as conventional laser cutting. Such laser-cut apertures can include, for example, holes for bolts or other fasteners for securing the components of the gate operator 21 within the housing 36. In another embodiment (not shown) where the sides of the metal sheet are not at slots 81 and 94 and openings 131 and 132, the laser-cut apertures can include the upper and lower slots 81 and 94 and the upper and lower openings 131 and 132.

In another step of the method of manufacturing of the gate operator 21, a plurality of bends or folds are provided in the sheet 151 so as to form the sheet into all or part of the circumferential wall 41 of elongate housing 36. In one embodiment, at least three such bends are formed in the sheet 151. FIG. 10 illustrates the sheet 151 after three such bends have been formed in the sheet 151. Certain of the wall portions of circumferential wall 41 are identified in FIG. 10 to facilitate in, the identification of such bends, which can include a first bend 161 for forming the 90 degree corner or fold between rear wall portion 43 and second side wall portion 47, a second bend or fold 162 for forming the 90 degree corner between the rear wall portion 43 and first side wall portion 46 and a third bend or fold 163 for forming the 90 degree corner between the first side wall portion 46 and front wall portion 42.

Additional sheets of metal 164, 165 and 166, which can be cut initially from the same stock from which sheet 151 was cut or be otherwise provided, can be utilized to form arcuate portion 48 of the circumferential all 41. An additional plurality of longitudinal bends 167 can be provided in each of the additional sheets 164-166 for forming the plurality of planar wall segments 168 that create the arc in arcuate portion 48 of the circumferential wall 41. In one embodiment, a sufficient plurality of bends 168 are formed in the sheets 164-166 to provide at least three planar wall segments 168 which together appear to form a rounded corner. In FIG. 10, four bends 167 are shown for forming five wall segments 168 in each of the sheets 164-166 to create the appearance of a rounded corner in each of the sheets. The three sheets 164-166 are each welded at one side to first side 156 of sheet 151 and at the other side to second side 157 of the sheet 151 in selected vertical positions to form arcuate portion 48 and a portion of slots 81 and 94 and access openings 131 and 132. More specifically, additional sheet 164 is welded to the top portion of the sheet 151 so that the top end of sheet 164 and sheet 151 form top end 38 of housing 36 and the bottom end of the sheet 164 forms the top of upper slot 81. Additional sheet 165 is welded to the central portion of sheet 151 so that the top end of sheet 164 forms the bottom of upper opening 131 and the bottom end of the sheet 164 forms the top of lower opening 132. Additional sheet 166 is welded to the bottom portion of the sheet 151 so that the bottom end of sheet 166 and sheet 151 form bottom end 39 of housing 36 and the top end of the sheet 166 forms the bottom of lower slot 94. In the foregoing manner, circumferential wall 41 of the housing 36 is made of folded metal. The one or more structural plates 141 can be inserted and welded or otherwise secured in place within cavity 66.

Upper and lower doors 133 and 134 can be created in a similar manner from additional sheets 164-166, whether from the same stock cut to form sheets 164-166 or otherwise. A similar plurality of bends 167 forming a similar plurality of wall segments 168 can be formed in each of the doors 133 and 134 so that each of the doors 133 and 134 can have the same cross-sectional shape of arcuate portion 48.

The method of creating gate operator 21 further includes welding or otherwise securing foot plate 54 to the bottom end 39 of circumferential wall 41 and welding or otherwise securing top plate 53 to top end 38 of the circumferential wall 41.

The method additionally includes mounting the internal components of gate operator 21 within internal cavity 66 of housing 36. In this regard, upper hinge assembly 67 and lower hinge assembly 68 are mounted in the vicinity of respective top end 38 and bottom end 39 of the housing 36 in the manner discussed above. In one embodiment, motor 101 is mounted inside the elongate housing 36 and pivotable member 106 of the motor is rigidly coupled to the lower hinge shaft 92 of the lower hinge assembly 68. Additionally, hydraulic pump 114 and controller 121 are mounted in internal cavity 66 in the manner discussed above. In one embodiment, motor assembly 144 is mounted in elongate housing 36, for example in the manner discussed above.

Gate 23 is mounted to upper hinge assembly 67 and lower hinge assembly 68 in any suitable manner. In one embodiment where the gate is made from metal, the upper attachment member 31 of the gate 23 is welded or otherwise suitably secured to upper hinge arm portion 78a and the lower attachment member 32 of the gate is similarly secured to lower hinge arm portion 93a so as to rigidly attach or affix the gate 23 to the upper and lower hinge arms 78 and 93.

In operation and use, gate operator 21 can be utilized with an exterior gate 23, which can be in the form of a driveway gate. The gate operator 21 is delivered to the site and mounted to the ground 22 adjacent the driveway. Installation of gate operator 21 is relatively simple as the integrated gate operator is mounted at a single location to ground 22, for example by bolting or by otherwise securing foot plate 54 of the gate operator 21 to a footing 61 provided in ground 22. The gate 23 is secured to upper and lower hinge arms 78 and 93 of the gate operator 21 in the manner discussed above so that the gate extends over all or the portion of the driveway intended to be governed by the gate.

When it is desired to open gate 23, a suitable signal is wirelessly or otherwise sent to controller 121 so as to cause pump 114 and motor 101 to rotate lower hinge arm 93 from its first or closed position, shown in FIGS. 1, 6 and 7, through an angle of approximately 90 degrees to its second or opened position, not shown in the figures. Gate 23, rigidly joined to the lower hinge arm 93 of the lower hinge assembly 68 and upper hinge arm 78 of the upper hinge assembly 67, follows such rotational movement of the lower hinge arm 93 and thus similarly moves though an angle of approximately 90 degrees from its closed position to its opened position. Upper and lower hinge arms 78 and 93 pivot in a first angular direction about vertical hinge axis 77, which is clockwise in FIG. 7, during opening of the gate 23, and in a second or opposite angular direction about the vertical hinge axis 77, which is counterclockwise in FIG. 7, during closing of the gate 23. Arcuate portion 48 of the elongate housing 36 is suitable contoured to not obstruct the movement of the hinge arms 78 and 93 or the gate 23 attached thereto during movement of the gate between its opened and closed positions. It is appreciated that the movement of motor pivotable member 106 and thus lower hinge arm 93 joined thereto can be selectively controlled so that the angle through which the gate 23 moves between its two extreme positions can be controlled and thus, for example, be other than 90 degrees.

Gate operator 21 of the present invention advantageously provides a gate post formed from a hollow elongate housing 36 having the essential elements of the gate operator mounted within the housing 36. Such central elements include, for example, upper hinge assembly 67, lower hinge assembly 68, motor 101 or motor assembly 144 for driving at least one of the hinge assemblies 67 and 68, hydraulic pump 114 when the motor 101 is an hydraulic motor, and an electronic controller 121 for controlling the operation of the motor and any pump 114 included in the gate operator 21. The inclusion of such essential elements within gate post 21 reduces the installation costs of a gate operator permitting the gate operator to be shipped as a single unit without the need of coupling together a separate gate post, controller and/or motor at the installation site, as is often the case with prior art gate operators.

The tubular structure of elongate housing 36 adds to the structural rigidity of the housing 36 and permits the gate operator 21 to be utilized with relatively heavy single or multiple segmented gates without bending or failure of the housing 36, in this regard, the tubular structure and cross-sectional dimensions of circumferential wall 41 provide the housing 36 with a construction for singularly supporting, that is free of any other support, the driveway gate 23 over the portion of the driveway governed by the gate.

Maintenance of the gate operator 21 is relatively simple as access doors 133 and 134 permit easy entry into internal cavity 66 of elongate housing 36 should the settings of controller 121 need to be altered or adjusted, or components of the operator 21 such as hinge assemblies 67 and 68, motor 101 and hydraulic pump 114 or motor assembly 144 need servicing or replacing. The placement of upper hinge assembly 67 and lower hinge assembly 68 inside housing 36 reduces the exposure of the assemblies 67 and 68 to nature and thus increases the longevity of the assemblies 67 and 68.

Gate operator 21 has an aesthetically pleasing appearance, which permits the operator 21 to be utilized in commercial and residential environments. Rounded arcuate portion 48 of circumferential wall 41 provides an elegant appearance to the gate operator 21. The inclusion of bands 84 for covering upper and lower slots 81 and 94 contributes to the aesthetic appearance of the gate operator 21, as well as inhibits foreign objects from entering the elongate housing 36 after installation of the gate operator 21.

In another aspect of the invention, a folded gate assembly 171 is provided that can utilize the gate operator of the present invention. Gate operator 172 therein can be substantially identical to gate operator 21 except that gate operator 172 is a right-swinging gate and gate operator 21 is a left-swinging gate operator. Like reference numerals have been used to describe like components of gate operators 172 and 21.

Gate assembly 171 includes a folded gate 176 of any suitable type and having a first gate segment 177 mounted to upper and lower hinge assemblies 67 and 68 of the gate operator 172 and a second gate segment 178 pivotably coupled to the first gate segment 177 by any suitable means such as upper and lower hinges 181. More specifically, first gate segment 177 has an upper end portion 177a welded or otherwise secured to upper hinge end portion 178a and a lower portion 177b welded or otherwise suitably secured to lower hinge end portion 93a. Similarly, second gate segment 178 has an upper end portion 178a pivotably coupled to upper end portion 177a of the first gate segment by a first hinge 181 and a lower end portion 178b pivotably coupled to the lower end portion 177b of the first gate segment by a second hinge 181. The first gate segment has a top surface or top 179 and the second gate segment has a top surface or top 180.

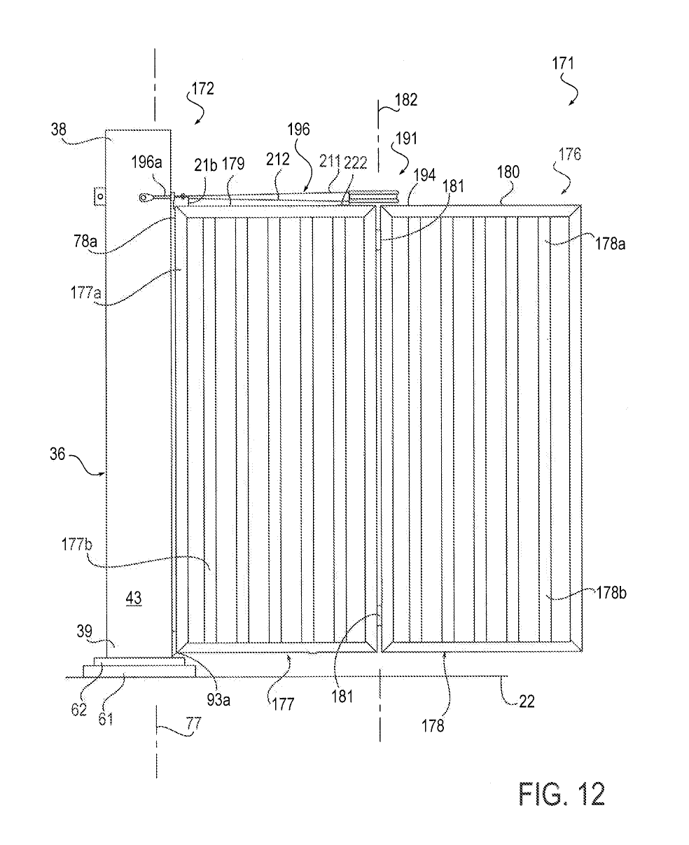

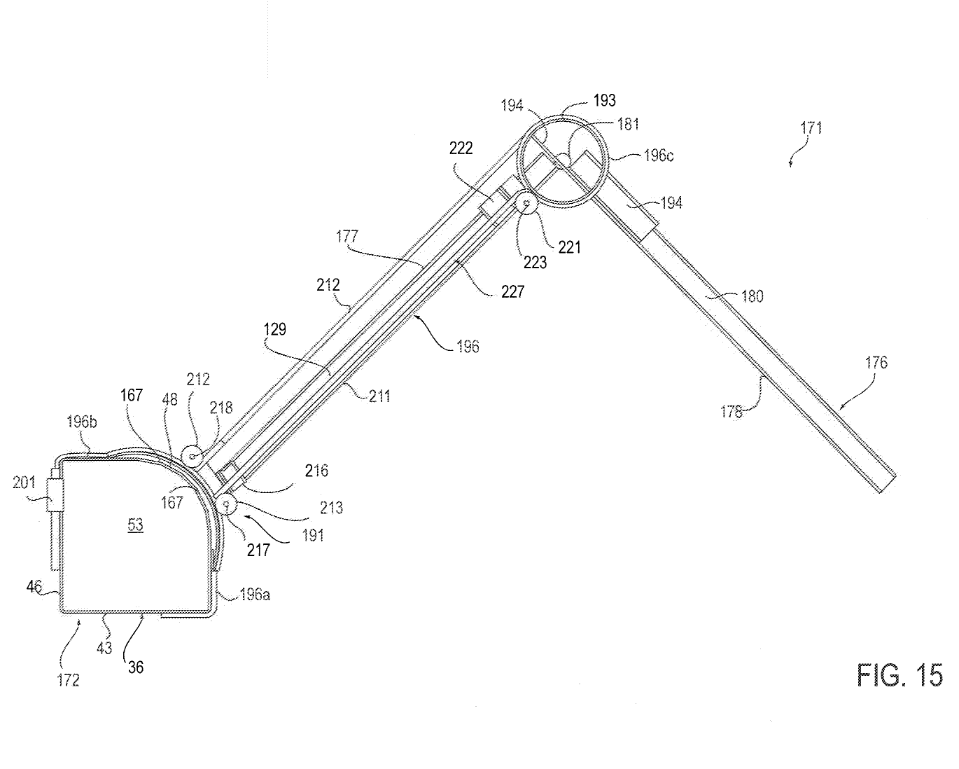

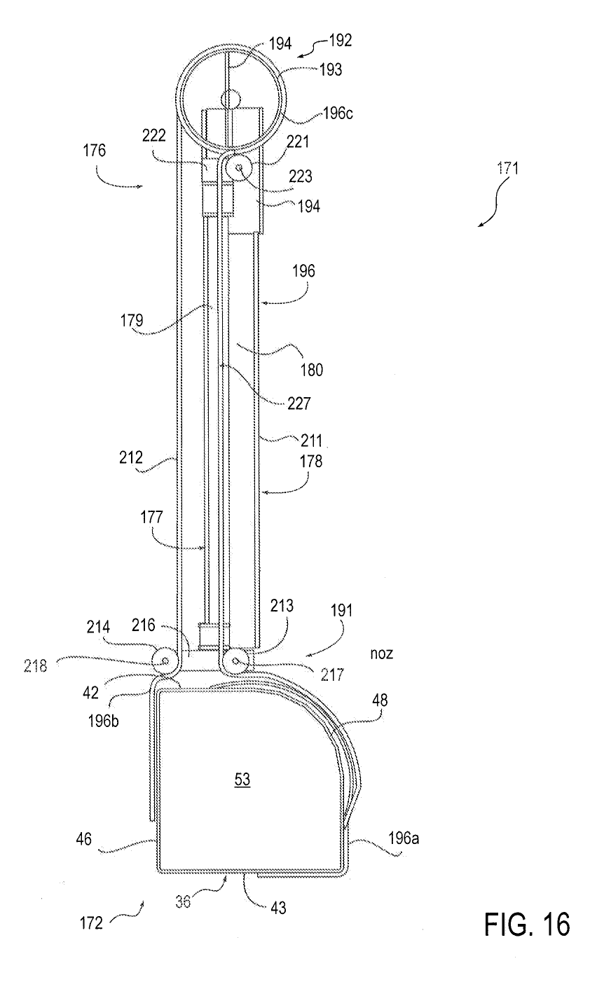

In the manner discussed above with respect to gate operator 21, gate operator 172 serves to pivot first gate segment 177 from a first position, shown in FIGS. 12-14, through an angle of approximately 45 degrees to a second position, shown in FIG. 15, and then additionally through an additional angle of 45 degrees to a third position, shown in FIG. 16. It is appreciated that the first gate segment 177 can be pivoted thought a variety of angles between its extreme positions, which can serve as opened and closed positions of the first gate segment 177. In the illustrated embodiment, the first gate segment pivots from its closed position in FIGS. 12-14 though an angle of approximately 90 degrees to its opened position in FIG. 16.

Hinges 181 permits second gate segment 178 to pivot through an angle of approximately 180 degrees between its fully extended position illustrated in FIGS. 12-14, in which the second gate segment extends outwardly from the first gate segment 177 in substantially the same plane as the first gate segment, and its fully folded position relative to the first gate segment illustrated in FIG. 16, in which the second gate segment 178 is folded back up against or in juxtaposition to the first gate segment and thus extends in a plane substantially parallel to and adjacent the first gate segment 177. Upper and lower hinges 181 are concentrically aligned so as to pivot about a second pivot axis 182 extending substantially parallel to first pivot axis 77 of the upper and lower hinge assemblies 67 and 68.

Folded gate assembly 171 includes a slave actuation assembly 191 that causes second gate segment 78 to pivot from its closed position of FIGS. 12-14 to its opened position of FIG. 16 as a result of the pivoting of the first gate segment 177 by gate operator 172 from its closed position of FIGS. 12-14 to its opened position of FIG. 16. In this regard, a pivot element or pivot 192 can be mounted to top upper end portion 178a of the second gate segment 178. Pulley or pivot 192 can be of any suitable type and in one embodiment is in the form of a tubular member or tube formed from a cylindrical or circular metal wall 193. In one embodiment, circular wall 193 has a diameter of approximately six inches and a height of approximately two inches. Pivot 192 can be mounted to the top 180 of second gate segment 178 by any suitable means such as a metal bracket 194 welded or otherwise suitably secured at one end to gate segment 178 and welded or other suitably secured at its other end to the inside of the circular wall 193. In one embodiment, the pivot 192 extends over and is aligned with hinges 181 so that the central axis of circular wall 193 is concentric with second pivot 182.

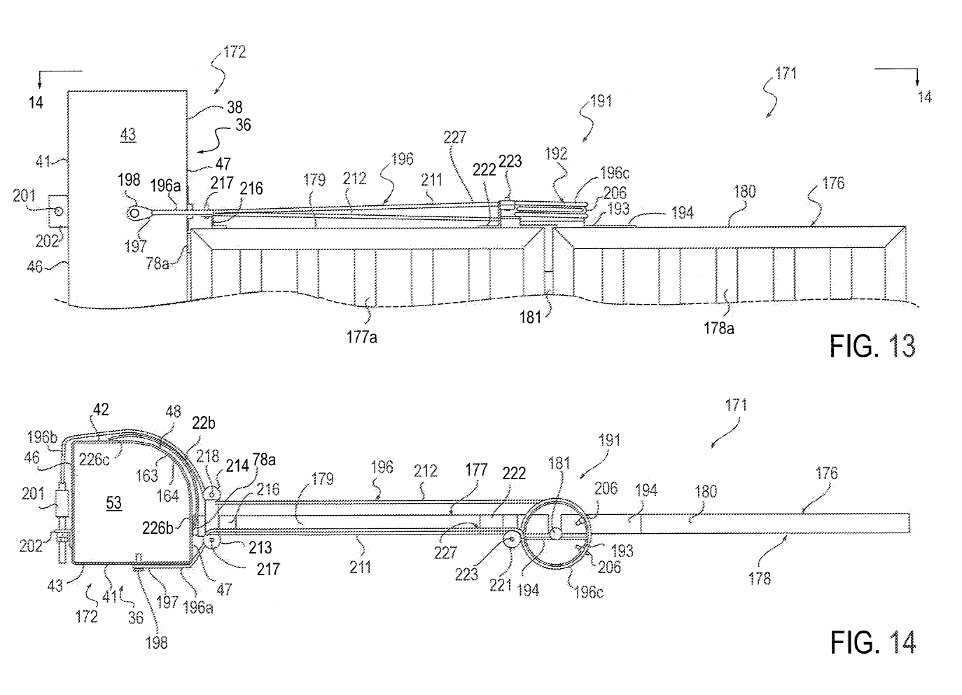

Slave actuation assembly 191 can further include an elongate flexible member, or flexible metal element, such as a metal cable 196. In one embodiment, cable 196 is a wire rope that can have any suitable diameter such as approximately 0.25 inch. The wire rope can be provided with a first end portion 196a, a second end portion 196b and a central portion 196c (see FIGS. 13-16). The wire rope or cable 196 can be mounted to gate operator 172 and pivot 192 so as to extend substantially in a plane extending perpendicular to pivot axes 77 and 182 and disposed above first and second gate segments 177 and 178 and adjacent top end 38 of elongate housing 36. More specifically, and as shown in FIG. 14, first end portion 196a of the cable is secured to one portion of the housing 36, for example rear wall portion 43, by any suitable means or manner. In one embodiment, first end portion 196a is suitably joined to an eye fixture 197 that is attached to rear wall portion 43 of housing 36 by any suitable means such as a bracket or fastener 198. The second end portion 196b of the cable is suitably joined to another portion of the housing 36, for example first side wall portion 46, by any suitable means or manner. In one embodiment, the second end portion 196b of the cable 196 is secured to a length adjustment mechanism 201 that is secured to first side wall portion 46 of the housing 36 by a bracket 202 welded or otherwise suitably secured to the circumferential wall 41. In this manner, and as shown in FIG. 14, cable first end portion 196 extends in a first direction around at least a portion of elongate housing 36 and cable second end portion 196b extends in an opposite second direction around at least a portion, such as another portion, of the elongate housing 36.

Cable second central portion 196c extends at least partially around circular wall 193 of pivot 192 and can extend at least once around circular wall 193 and can, as illustrated in FIGS. 13-14, extend at least twice around circular wall 193 of pivot 192. The central portion 196c of the cable 196 can be optionally secured to circular wall 193 and in one embodiment is secured to the circular wall 193 at first and second locations by any suitable means such as first and second U-shaped fasteners 206. As illustrated in FIGS. 13-14, central portion 196c of the cable adjoining cable second end portion 196b commences circling pivot 192 at the bottom of circular wall 193 and extends from the top of the circular wall 193 towards adjoining cable first end portion 196a.

A plurality of tensioning elements can be provided in actuation assembly 191 for directing and guiding the first and second portions or segments of the cable 196 extending between gate operator 172 and pivot 192. In this regard, cable 196 has a first segment 211 extending between first end portion 196a and the central portion 196c of the cable and a second segment 212 extending between second end portion 196b and the central portion 196c of the cable. The tensioning elements can include first and second rollers 213, 214 mounted to first gate segment 177 adjacent elongate housing 36 (see FIG. 14). A bracket 216 is welded or otherwise suitably secured to top 179 of first gate segment 177 adjacent housing 36 and is provided with first and second upstanding pins 217 and 218 for respectfully receiving and securing first and second rollers 213, 214 to the first gate segment 177. Pins 217 and 218 and thus rollers 213 and 214 are spaced apart in a plane extending substantially perpendicular to the plane of the first gate segment. A third tensioning element in the form of a third roller 221 can be included within actuation assembly 191 and can be pivotably coupled to upper end portion 177a of the first gate segment adjacent pivot 192. A metal bracket 222 is welded or otherwise suitably secured to top 179 of the first gate segment 177 and has an upstanding third pin 223 for rotatably receiving and retaining the third roller on the first gate segment 177.

First segment 211 of the cable extends between the first and second rollers 213 and 214, and more specifically wraps at least partially around first roller 213 at one end of the segment 211 and wraps at least partially around third roller 221 between the third roller and the circular wall 193 at the other end of the segment 211 (see FIG. 14). First roller 213 and third roller 221 can be centered in a plane extending substantially parallel to the plane of the first gate segment 177 and serve to cause the first segment 211 of the cable to extend substantially over the first gate segment. The second segment 212 of the cable extends between the first and second rollers 213 and 214 and more specifically extends at least partially around second roller 214. The second roller 214 is horizontally aligned relative to the first gate segment 177 so that the second segment 212 of the cable 196 extends substantially parallel to the plane of the first gate segment 177 between second roller 214 and circular wall 193 of the pivot 192. In this manner, the rollers 213, 214 and 221 and pivot 192 cause the first and second segments 211 and 212 of the cable 196 to extend substantially parallel to each other between elongate housing 36 and pivot 192.

An arcuate strip 226 formed from any suitable material such as metal can be disposed between the second end portion 196b of the cable and arcuate portion 48 of the elongate housing 36. Arcuate strip 226 has a first end portion 226a that can be joined to front wall portion 42 of the housing by any suitable means as one or more fasteners (not shown) and a second end portion 226b that can be joined to second side wall portion 47 of the housing by any suitable means such as one or more fasteners (not shown). The second end portion 196b of the cable 196 engages a smooth arcuate outer surface of strip 226 and inhibits the formation of burrs or breaks in the cable which may otherwise occur if the cable engaged bends 167 formed in circumferential wall 41 between wall segments 168 of the arcuate portion 48 of the wall 41.

In operation and use, gate operator 172 can be installed at a desired location in the manner discussed above with respect to gate operator 21 and folded gate 176 can be attached to the upper and lower hinge arms 78 and 93 in the manner discussed above. When it is desired to open the folded gate 176, activation of the gate operator 172 causes first gate segment 177 to pivot in a first angular direction about vertical hinge axis 77, shown as being counterclockwise in FIGS. 14-16, from its closed position in FIG. 14 to its opened position in FIG. 16. Such angular or pivotable movement of the first gate segment causes cable 196 to rotate circular wall 193 of the pivot 192 relative to the first gate segment and thus cause the second gate segment 178 to pivot in a second or opposite angular direction about second pivot axis 182, shown as being clockwise in FIGS. 14-16, through an angle of approximately 180 degrees from its closed position in FIG. 14 to its opened position in FIG. 16 in which the second gate segment is folded adjacent the first gate segment. When it is desired to close folded gate 176, gate operator 172 causes the first and second gate segments 177 and 178 to pivot in opposite respective angular directions to the angular directions during opening of the gate 176 so as to cause the second gate segment 178 to unfold relative to the first gate segment 177.

During pivoting of the first gate segment 177 between its opened and closed positions, rollers 213, 214 and 221 maintain cable 196 taught. Since the cable 196 is fixed at each end to the elongate housing 36 of the gate operator 172, movement of the rollers 213-214 across the face of arcuate portion 48 of the housing 36 causes central portion 196c of the cable to simultaneously wind and unwind about circular wall 193 of the pivot 192. Since the cable central portion 196c is secured to the circular wall 193, the simultaneous winding and unwinding of the cable central portion 196c on circular wall 193 causes the pivot 192 and the second gate segment 178 secured to the pivot 192 to rotate about second pivot axis 182. More specifically, as the folded gate 176 is opened, first segment 211 of the cable 196 is pulled or drawn by first roller 213 so as to unwind the top portion of cable central portion 196c joined to the first segment from the circular wall 193 of pivot 192. Imaginary reference point 227 marked on the first cable segment 211 in FIGS. 13-16 illustrates the linear travel of the cable first segment 211 relative to the first gate segment 177 and pivot 192, that is such unwinding of the top portion of cable central portion 196c as the first and second gate segments 177 and 178 are pivoted from their respective closed positions of FIGS. 12-14 to their respective opened positions of FIG. 16. Similarly, as the folded gate 176 is opened, second segment 212 of the cable 196 is simultaneously released by or fed out from second roller 214 so as to wind the top portion of cable central portion 196c joined to the second segment about the circular wall 193 of pivot 192.

A length adjustment mechanism 201 can be joined to second end portion 196b of the cable permits longitudinally adjustment and tightening of the cable 196 during installation of the gate assembly 171 and thereafter so that the second gate segment 178 desirably pivots relative to the first gate segment 177 as the first gate segment is moved between its opened and closed positions.

Slave actuation assembly 191 is relatively simple in construction and thus relatively inexpensive and easy to maintain. The utilization of cable 196 in the assembly 191 is advantageous because cable is not prone to stretching. Any such stretching could result in undesirable misalignment of the second gate segment 178 relative to the first gate segment 177. Nonetheless, it is appreciated that a chain (not shown) could be used in place of cable 196 for the elongate flexible member of slave actuation assembly 191.

It is appreciated that another suitable or similar slave actuation assembly may be provided to cause a third gate segment (not shown) to pivot relative to second gate segment 178 in the same manner that second gate segment 178 has been described as pivoting relative to first gate segment 177. It is also appreciated that a slave actuation assembly having a wire rope, elongate flexible member or cable 196 configured in another suitable manner can be provided for pivoting second gate segment 178 relative to first gate segment 177 in the manner discussed above for opening and closing a folded gate assembly of the present invention. In one embodiment of such a slave actuation assembly, a pivot element or pivot 192 could be provided, coaxial with hinges 181 in the manner discussed above, and the elongate flexible member would wind around pivot 192 for pivoting the second gate segment 178 is a first direction relative to the first gate segment 177 and unwind about pivot 192 for pivoting the second gate segment 178 in an opposite second direction relative to the first gate segment 177.

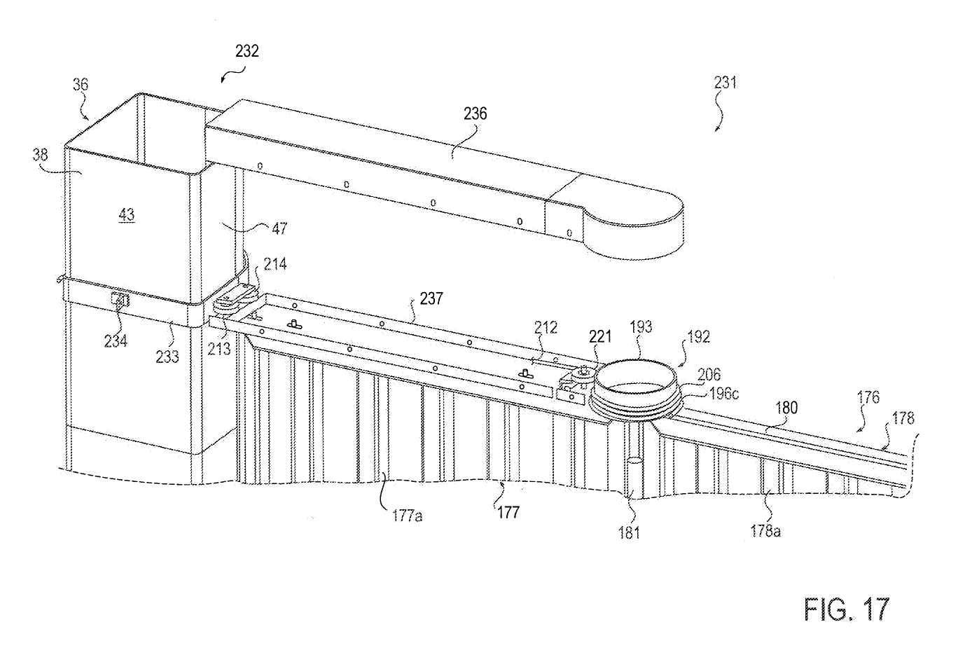

A cover or enclosure, not shown and made from any suitable material such as metal or plastic, may be provided for hiding slave actuation assembly 191 and protecting the assembly 191 from nature and other damage after installation of folded gate assembly 171. Another embodiment of a folded gate assembly having a cover or enclosure for the slave actuation assembly 191 is illustrated in FIG. 17. Folded gate assembly 231 illustrated in FIG. 17 is substantially identical to folded gate assembly 171 and like reference numerals have been used to describe like components of folded gate assemblies 171 and 231. Assembly 231 includes a gate operator 232 substantially identical to gate operator 172 and like reference numerals have been used to describe like components of gate operators 172 and 232. Slave actuation assembly 191 of the gate operator 232 includes a metal band 233 secured around the housing 36 for securing first end portion 196a and second end portion 196b (not shown) of the cable 196 to the housing 36. The band 233 can be formed with a bracket 234, for example, for securing cable first end portion 196a to the band and thus the housing in a conventional manner, and a similar bracket can be provided in the band 233 for securing cable second end portion 196b to the band and thus the housing 36. Cover 236 of gate assembly 231 can be sized and shaped to extend over first gate segment 177, pivot 192, cable central portion 196c extending around the pivot 192, and cable first and second segments 211, 212 extending over the first gate segment 177. The cover 236 can be secured to the folded gate assembly 171 in any suitable manner, and in one embodiment is secured to the first gate segment 177 by means of a bracket 237 bolted, welded or otherwise suitably mounted to the top of the first gate segment 177, and bolts or other fasteners (not shown) that removably mount the cover 236 to the bracket 237.

All directional references, for example upper, lower, upward, downward, left, right, leftward, rightward, top, bottom, above, below, vertical, horizontal, clockwise, counterclockwise, x-axis, y-axis, and z-axis, are only used for identification purposes to aid the reader's understanding of the embodiments of the present invention, and do not create limitations, particularly as to the position, orientation, or use of the invention unless specifically set forth in the claims. Joinder references, for example attached, coupled, and connected, are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to preferred embodiments, persons skilled in the art will recognize that changes may be made in form and detail without departing from the spirit and scope of the invention.

We claim:

1. A gate operator for use on ground to open and close an exterior gate, comprising an elongate hollow housing adapted for rigid vertical mounting relative to the ground and having top and bottom ends, first and second spaced-apart hinge assemblies adapted to secure to the gate and mounted within the housing inside the respective top and bottom ends for pivoting relative to the housing about a vertical hinge axis extending along the housing, a motor having a pivotable member for rotation about a motor axis, the motor mounted within the housing between the top and bottom ends with the motor axis coincident with the vertical hinge axis and the pivotable member coupled to at least one of the first and second hinge assemblies so that the motor causes the at least one of the first and second hinge assemblies to pivot between first and second positions and thus cause the gate to pivot between opened and closed positions.

2. The gate operator of claim 1, wherein the motor is mounted within the housing between the first and second hinge assemblies.

3. The gate operator of claim 1, wherein the motor is an hydraulic motor, further comprising an hydraulic pump mounted within the housing and coupled to the hydraulic motor.

4. The gate operator of claim 1, where in the hydraulic motor includes a rack and pinion gearbox.

5. The gate operator of claim 1, wherein the motor is an electric motor.

6. The gate operator of claim 1, further comprising an electronic controller disposed within the housing and coupled to the motor for controlling the operation of the motor.

7. The gate operator of claim 1, wherein the bottom end portion of the housing includes a base plate adapted for bolting the housing to the ground.

8. The gate operator of claim 1, wherein the gate is a driveway gate and the housing has a construction for supporting the driveway gate over the ground.

9. The gate operator of claim 8, wherein the housing is made of folded metal.

10. The gate operator of claim 8, wherein the housing is made laser-cut metal.

11. The gate operator of claim 8, wherein the housing has a circumferential metal wall.

12. The gate operator of claim 11, wherein the housing is cylindrical and provided with a horizontal cross section that is relatively constant along the vertical hinge axis.

13. A gate operator for use on ground to open and close an exterior gate, comprising an elongate hollow housing adapted for vertical mounting relative to the ground and having top and bottom ends, first and second spaced-apart hinge assemblies adapted to secure to the gate and mounted within the housing inside the respective top and bottom ends for pivoting relative to the housing, a motor mounted within the housing between the first and second hinge assemblies and coupled to at least one of the first and second hinge assemblies for causing the at least one of the first and second hinge assemblies to pivot between first and second positions and thus pivot the gate between opened and closed positions.

14. The assembly of claim 13, wherein the motor is an hydraulic motor, further comprising an hydraulic pump mounted within the housing and coupled to the hydraulic motor.

15. The assembly of claim 13, wherein the motor is an electric motor.

16. The assembly of claim 13, wherein the gate is a driveway gate and the housing has a peripheral metal wall for singularly supporting the driveway gate relative to the ground.

17. The assembly of claim 13, further comprising an electronic controller disposed within the housing and coupled to the motor for controlling the operation of the motor.

18. A gate operator for use on ground to open and close an exterior gate, comprising an elongate hollow housing adapted for vertical mounting relative to the ground and having top and bottom ends, first and second spaced-apart hinge assemblies adapted to secure to the gate and mounted within the housing inside the respective top and bottom ends for pivoting relative to the housing, a motor mounted within the housing and coupled to at least one of the first and second hinge assemblies for causing the at least one of the first and second hinge assemblies to pivot between first and second positions and thus pivot the gate between opened and closed positions and an electronic controller disposed within the housing and coupled to the motor for controlling the operation of the motor.

19. The gate operator of claim 18, wherein the housing has a circumferential wall made of folded metal.

20. The gate operator of claim 19, wherein the circumferential wall has a plurality of laser-cut apertures formed therein.

21. A method for manufacturing a gate post for use with an exterior gate, comprising providing a sheet of metal having a length and first and second sides, laser cutting a plurality of apertures in the sheet of metal, forming at least three bends in the sheet of metal to bring together the first and second sides of the sheet of metal to form a tubular housing having top and bottom ends and having a length approximating the length of the sheet of metal, welding together the first and second sides of the sheet of metal and mounting first and second spaced-apart hinge assemblies adapted to secure to the exterior gate within the housing adjacent the top and bottom ends.

22. The method of claim 21, wherein the laser cutting step includes laser cutting at least one door from the sheet of metal to access the interior of the housing.

23. The method of claim 21, further comprising mounting a motor within the housing and coupling the motor to at least one of the first and second hinge assemblies.

24. The method of claim 23, further comprising mounting an electronic controller in the housing and coupling the controller to the motor for controlling the operation of the motor.

25. The method of claim 21, wherein the forming step includes forming a sufficient plurality of bends in the sheet of metal so that the housing has at least one corner formed from at least three planar segments which together appear to form a rounded corner.

26. The method of claim 21, further comprising mounting a foot plate to the bottom end of the housing.

27. A folded gate assembly, comprising a gate post having an elongate housing with top and bottom ends and having top and bottom hinge assemblies mounted to the housing adjacent the top and bottom ends and provided with respective top and bottom hinge arms, a first gate segment mounted to the top and bottom hinge arms for pivoting about a first pivot axis relative to the elongate housing and a second gate segment coupled to the first gate segment for pivoting relative to the first gate segment about a second pivot axis extending substantially parallel to the first pivot axis, a pivot element mounted to the second gate segment concentric with the second pivot axis and a cable having first and second end portions secured to the elongate housing and a central portion extending at least partially around the pivot element so that when the first gate segment pivots in a first direction about the first pivot axis the cable causes the pivot element and thus the second gate segment to pivot in an opposite second direction about the second pivot axis and thus fold the second gate segment adjacent the first gate segment as the first and second gate segments are moved to an opened position.

28. The gate assembly of claim 27, wherein the second gate segment has a top, the pivot element being mounted to the top of the second gate segment and the first and second end portions of the cable being mounted to the elongate housing adjacent the top end of the elongate housing.

29. The gate assembly of claim 27, wherein the pivot element has a circular portion and the central portion of the cable extends at least partially around the circular portion.

30. The gate assembly of claim 27, wherein the central portion of the cable extends at least once around the pivot element.

31. The gate assembly of claim 30, wherein the central portion of the cable extends at least twice around the pivot element.

32. The gate assembly of claim 27, wherein the first end portion of the cable extends in a first direction around at least a portion of the elongate housing and the second end portion of the cable extends in an opposite second direction around at least a portion of the elongate housing.

33. The gate assembly of claim 27, further comprising first and second rollers mounted to the first gate segment adjacent the elongate housing, the cable having first and second segments extending between the first and second rollers from the elongate housing to the pivot element with the first segment engaging the first roller and the second segment engaging the second roller.

34. The gate assembly of claim 33, further comprising an additional roller mounted the first gate segment adjacent the second gate segment for engaging one of the first and second segments of the cable, the first and second segments extending substantially parallel to each other between the elongate housing and the pivot element.
